(19) United States
(12) Patent Application Publication
(10) Pub. No.: US 2020/0373754 A1
(43) Pub. Date: Nov. 26, 2020

(54) DEVICE FOR PROTECTING ELECTRICAL EQUIPMENT

(71) Applicant: CALY TECHNOLOGIES, Villeurbanne (FR)

(72) Inventors: Dominique TOURNIER, Lyon (FR); Maxime BERTHOU, Villeurbanne (FR); Gonzalo PICUN, Saint Laurent Du Pont (FR)

(21) Appl. No.: 16/476,205

(22) PCT Filed: Jan. 11, 2018
(86) PCT No.: PCT/EP2018/050607

§ 371 Date: Jul. 5, 2019

(30) Foreign Application Priority Data
Jan. 11, 2017 (FR) 1750242

(51) Int. Cl. H02H 9/02

(52) U.S. Cl. CPC H02H 9/025

(57) ABSTRACT

The present invention relates to a device for protecting electrical equipment (23), comprising:
a first branch (21) for limiting current including a current source;
a second conduction branch (22) mounted parallel to the limitation branch (21), the impedance of the conduction branch (22) being less than or equal to 10% of the impedance of the limitation branch (21);
a control unit (3) for switching the operating mode of the device between:
   a first operating mode, in which the electric current circulates through the limitation branch (21) without circulating in the conduction branch (22); and
   a second operating mode, in which the electric current circulates through the limitation and conduction branches (21, 22).

### FIELD OF THE INVENTION

The present invention relates to the field of electrical equipment protection circuits and, in particular, power supply and/or electrical energy distribution systems of the direct or alternating current type.

### BACKGROUND OF THE INVENTION

In (direct or alternating current) electrical applications, a current overload may cause an overvoltage, damaging the electrical equipment.

Current overloads, and more generally overcurrents may have several origins:

an overcurrent may be caused by a short-circuit, an overvoltage or a lightning,

an overcurrent may also occur during the startup phase or upon connection of electrical equipment to the grid.

Different types of protection devices are known to reduce the effects of these current overloads and in particular the risks of deterioration of the electrical equipment.

Such protection devices may be used, for example, upstream of a storage capacitor mounted in parallel of an electrical equipment to be protected.

1. Limiting Resistor

A first solution to reduce the risks of deterioration of the electrical equipment consists in electrically connecting a serial limiting resistor of the equipment to be protected.

This limiting resistor is useful for limiting the strong current draw at startup of the equipment to be protected, and more precisely during the pre-charge of the storage capacitor.

However, a drawback to this solution is that, once the startup phase is over, this limiting resistor (which is no longer useful) heats and tends to dissipate a lot of energy.

2. Limiting Resistor with a Switch

In order to overcome this drawback, the assembly illustrated in FIG. 1 has already been proposed, in which the limiting resistor 17 is positioned on a limitation branch 11 electrically connected in parallel with a conduction branch 12—such as an electric wire. A similar assembly is in particular described in document EP 2 653 950.

In this case, the switching between the limitation branch 11 and the conduction branch 12 is monitored by an electric switch 13.

The operating principle of such an assembly is as follows.

At startup, the electric switch 13 is connected to the limitation branch 11 so that the electric current derived from the supply source 14 flows through the limitation branch 11. The passage of current through the resistor 17 makes it possible to limit the strong current draw at startup of the equipment to be protected 15. The storage capacitor 16 is being charged.

After a given time (that may vary between a few milliseconds and a few seconds depending on the application), the electric switch 13 switches the circulation of the current from the limitation branch 11 to the conduction branch 12. This makes it possible to limit the energy losses related to the use of the limiting resistor 17.

However, a drawback of the assembly illustrated in FIG. 1 is that it does not allow keeping the electronic equipment 15 under-voltage upon switching of the electric switch 13.

In addition to the problems described above, another drawback of the above-mentioned protection devices using a limiting resistor 17 is that they do not allow charging the constant current storage capacitor 16, the limiting resistor 17 combined with the storage capacitor 16 constituting an RC circuit. This induces an accelerated aging of the storage capacitor. Moreover, this does not make it possible to predict the value of a fault current in case of abnormal operation, the latter may vary depending on the equivalent resistance of the circuit (taking into account the optional resistances of the components upstream and downstream of the protection device), this uncertainty about the fault current may induce one of the risks on the protection of the electronic equipment downstream of the protection device.

An object of the present invention is to propose a device for protecting an electrical equipment that makes it possible to overcome at least one of the aforementioned drawbacks.

### SHORT DESCRIPTION OF THE INVENTION

To this end, the invention proposes a device for protecting an electrical equipment including:

an input terminal intended to be electrically connected to an electrical energy supply source,

an output terminal intended to be electrically connected to the electrical equipment, remarkable in that the protection device comprises:

a first current limitation branch including a current source to produce (i.e. maintain) a constant electric current for a given voltage range,

a second conduction branch mounted in parallel with the limitation branch,

a control unit to switch the operating mode of the device between:

a first operating mode in which the electric current derived from of the electrical energy supply source flows through the limitation branch without flowing into the conduction branch, and

a second operating mode in which the electric current derived from the electrical energy supply source flows through the limitation and conduction branches, the impedance of the conduction branch being less than or equal to 10% of the impedance of the limitation branch in the second operating mode.

Preferred but non-limiting aspects of the system according to the invention are the following:

the control unit may be electrically connected to the conduction branch in order to monitor the activation and deactivation of said conduction branch so as to switch the device between the first and second operating modes, the limitation branch not being monitored by the control unit;

the current source may comprise a transistor, such as a JFET transistor or a MOSFET transistor:

the drain of the transistor being connected to the input terminal, and

the gate and the source of the transistor being connected to the output terminal;

the current source may comprise a two-terminal current limitation semiconductor element such as a current limiting diode for example made of silicon or silicon carbide, or any other semiconductor material;

the current limitation branch may further comprise an electrical resistor mounted in series with the current source;

the conduction branch may comprise a controlled switch like a transistor, such as a JFET transistor, a MOSFET transistor (or a bipolar transistor):

the drain (or the collector) of the transistor being connected to the input terminal,

the source (or emitter) of the transistor being connected to the output terminal,

the gate (or the base) of the transistor being connected to the control unit;

the control unit may comprise:

a circuit for detecting a voltage variation at the output of the electrical equipment protection device, and/or

a circuit for detecting a current variation at the output of the electrical equipment protection device;

the control unit may comprise a self-bias circuit to delay the activation of the conduction branch;

the control unit comprises a control circuit to generate a signal for blocking the conduction branch when the voltage and/or intensity at the output of the protection device is greater than a threshold value;

The limitation and conduction branches can be integrated into a monolithic component such as a JFET transistor or a MOSFET transistor.

### SHORT DESCRIPTION OF THE DRAWINGS

Other advantages and characteristics of the system according to the invention will become more apparent from the following description of several variants, given by way of non-limiting examples, from the attached drawings in which:

FIG. 1 is a schematic representation of a device of the prior art for the protection of a load,

FIG. 2 is a block diagram of a load protection device according to the present invention,

FIG. 3 is a block diagram of a first variant of the load protection device according to the present invention,

FIG. 4 is a block diagram of a second variant of the load protection device according to the present invention,

FIG. 5 is a block diagram of a third variant of the load protection device according to the present invention,

FIG. 6 is a graph illustrating current curves as a function of the voltage at the terminals of a current limitation branch including:

a resistance on the one hand (curve 80), and

a current source on the other hand (curve 81),

FIG. 7 is a graph illustrating current curves as a function of the voltage at the terminals of the protection device in:

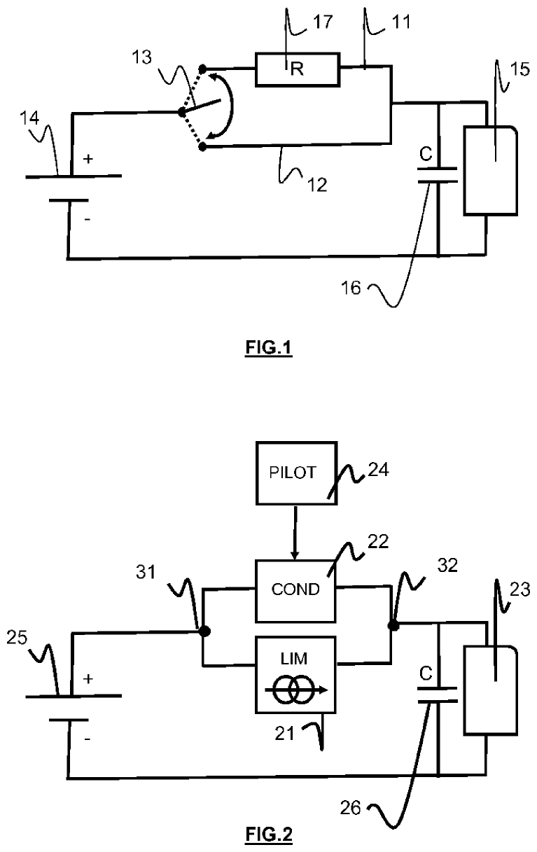

a first operating mode where the current flows through a limitation branch (curve 82),

a second operating mode where the current flows simultaneously through a limitation branch and a conduction branch (curve 83).

### DETAILED DESCRIPTION OF THE INVENTION

Various examples of load protection device will now be described according to the present invention with reference to FIGS. 2 to 5. In these various figures, the equivalent elements are designated by the same numerical reference.

1. General Information about the Protection Device

With reference to FIG. 2, the device for protecting an electrical load comprises an input terminal 31 intended to be connected electrically in series to an electrical energy supply source, and an output terminal 32 intended to be electrically connected to an electrical load to be protected 23.

Between the input 31 and output 32 terminals, the device comprises two branches each having a respective function:

A first branch 21—called “current limitation branch”—making it possible to limit the current flowing through the load 23 when an operating anomaly—such as an electric fault (for example a short-circuit)—is detected,

A second branch 22—called “conduction branch”—having a weak impedance to limit the voltage drop across the load 23 when the electric current derived from the electrical energy supply source 25 passes through said conduction branch 22.

The device also comprises a control unit 24 to allow the passage of the current:

either through the limitation branch 21 only according to a first operating mode,

or through the limitation and conduction branches 21, 22 simultaneously according to a second operating mode.

Thus, and whatever the operating mode of the device, the limitation branch 21 is still electrically conductive, so that the load 23 to be protected is always supplied, even during the transition between the first and second operating modes. The conduction branch 22 is, for its part, electrically conductive only in the second operating mode.

The first operating mode is advantageously activated when an anomaly—such as electric voltage or current overload—is detected.

In the variant illustrated in FIG. 2, the control unit monitors only the activation and deactivation of the conduction branch 22, the limitation branch 21 not being monitored by the control unit 24. This makes it possible to simplify the assembly of the load protection device.

The device illustrated in FIG. 2 makes it possible to effectively protect the load 23 of an electric circuit by limiting the current passing therethrough when an operating anomaly is detected.

Indeed, when an anomaly (overcurrent and/or overvoltage) is detected, the control unit 24 monitors the deactivation of the conduction branch 22 to induce the passage of the electric current (generated upstream of the input terminal) through the limitation branch 21.

By limiting the current flowing in the load 23 when an anomaly is detected, the protection device illustrated in FIG. 2 allows reducing the risks of degradation of the electric components located downstream of the output terminal.

2. Current Limitation Branch

The current limitation branch 21 makes it possible to limit the current flowing into the load 23 to a target intensity value when the second operating mode of the device is activated. This target value is expected to be sufficient to ensure the proper operation of the load 23.

Advantageously, the limitation branch 21 comprises one (or several)—particularly unidirectional—current source(s) to allow passage of the current from the input terminal 31 to the output terminal 32. Within the scope of the present invention, “current source” means one (or several) electric component(s) arranged to produce a constant electric current for a given voltage range.

More precisely and as illustrated in FIG. 6 by the curve 81, when the voltage V at the terminals of the limitation branch 21 is comprised within a given voltage range (particularly when the voltage V is greater than “+V_{LIM}”, or when the voltage V is less than “−V_{LIM}”), the current source maintains the intensity I of the current at a constant value (particularly a constant value equal to “+I_{LIM}” when V≥+V_{LIM}, or equal to “−I_{LIM}” when V≤V_{LIM}) by dynamically varying its impedance.

The dynamic variation of the impedance of the current source corresponds—in the case of a current source consisting of a JFET-type Normally-on transistor—to the passage from a linear conduction mode to a conduction mode in saturation state. This occurs when the voltage at the terminals of the transistor forming a current source becomes greater than a saturation voltage Vsat of said transistor. In saturation state, the impedance varies dynamically with the voltage so that the current is maintained constant. The operation is then analogous to that of a current source that produces and maintains a constant current whatever the voltage at its terminals.

The fact that the limitation branch 21 comprises a current source makes it possible to charge a storage capacitor 26 (mounted in parallel with the load 23 to be protected) with a constant current. This is not possible in the case of a limitation branch including a resistance, as shown in FIG. 6 by curve 80. Indeed, if the limitation branch comprises a resistance, then the current I at the terminals of the limitation branch varies linearly as a function of the voltage V applied at its terminals, so that a storage capacitor disposed at the output of the limitation branch is not charged at constant current.

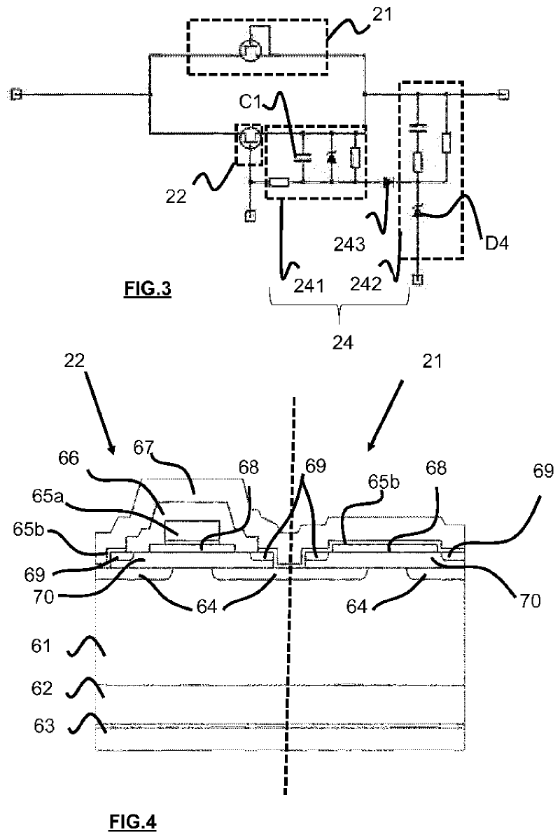

In the variant illustrated in FIG. 3, the current source comprises a transistor, such as a JFET transistor or a MOSFET transistor. The transistor drain is electrically connected to the input terminal 31 of the device, while the gate and the source of the transistor are electrically connected to the output terminal 32 of the device. The use of a JFET or MOSFET transistor has the advantage of facilitating the implementation of the device.

Alternatively, the current source may consist of a current limiting diode made of silicon carbide. The use of a current limiting diode makes it possible to avoid the presence of a control electronics. In addition, the fact that the diode is made of Silicon Carbide makes it possible to have a component capable of withstanding high energy levels, in the order of 0.1 J to 50 J.

Advantageously, the limitation branch 21 may comprise one (or several) resistive element(s) of heat dissipation mounted in series with the current source(s). This makes it possible to dissipate a greater electric power by Joule effect in case of current overload between the power supply source 25 and the load 23.

3. Conduction Branch

The conduction branch 22 makes it possible to ensure the circulation of the electric current in steady state. It preferably has a low impedance to limit the voltage drops across the load 23. For example, the impedance of the conduction branch 22 may be less than 1 ohm, preferentially less than 0.1 ohm, and even more preferably less than 0.01 ohms.

The conduction branch 22 may comprise a switch that can be controlled by the control unit 24. This switch can be of any type known to those skilled in the art. In particular, the switch is for example a mechanical switch or a hybrid switch.

However, the switch of the conduction branch 22 must be able to switch from a closed state to an open state very quickly after detection of an anomaly (overcurrent and/or overvoltage).

This is why the switch of the conduction branch 22 is preferably a static switch. This has the advantage of switching very quickly between a closed state and an open state (switching time less than or equal to a hundred microseconds). Another advantage of using a static switch is that it can withstand high voltages and strong currents.

In the variant illustrated in FIG. 3, the switch of the conduction branch consists of a transistor, such as a JFET transistor or a MOSFET transistor (or a bipolar transistor):

the drain (or the collector) of the transistor being connected to the input terminal,

the source (or emitter) of the transistor being connected to the output terminal,

the gate (or the base) of the transistor being connected to the control unit.

4. Control Unit

The control unit 24 makes it possible to control the activation and deactivation of the conduction branch 22.

More precisely, the control unit 24 makes it possible to open or close the conduction branch 22 so that the current flowing in the protection device passes through:

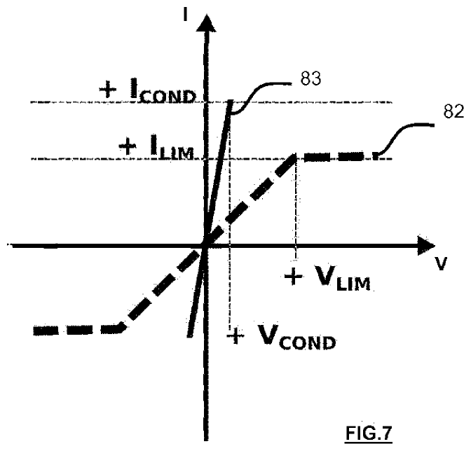

either the limitation branch only according to a first operating mode represented by the curve 82 of FIG. 7.

or the limitation and conduction branches together according to a second operating mode represented by the curve 83 of FIG. 7.

Preferably, the impedance of the conduction branch 22 is chosen to be lower than or equal to 10% of the impedance of the limitation branch 21 in the second operating mode. The passage of the current through the conduction branch 22 is thus favored in the second operating mode. This makes it possible to limit the losses by Joule effect when the second operating mode of the protection device is activated.

In the variant illustrated in FIG. 3, the control unit 24 comprises a circuit 242 for detecting a voltage variation at the output of the load protection device. Alternatively or in combination, the control unit may comprise a circuit for detecting a current variation at the output of the protection device. This (or these) detection circuit(s) allow(s) the identification of an anomaly (overvoltage and/or overcurrent) that could damage the load 23.

When a voltage variation detected by the detection circuit 242 exceeds a threshold voltage defined by an avalanche component D4 such as a Zener diode, a control circuit 243 of the control unit 24 transmits a blocking signal on the gate of the controllable switch of the conduction branch 22.

This blocking signal induces the opening of the controllable switch so as to deactivate the conduction branch 22. The current then flows exclusively through the current limitation branch 21.

When the voltage variation detected by the detection circuit 242 becomes lower than the threshold voltage, the control circuit 243 no longer emits a blocking signal. The controllable switch returns to an on-state so as to activate the conduction branch 22. The current then flows both through the limitation branch 21 and through the conduction branch 22.

Advantageously, the control unit 24 may comprise a self-bias circuit 241 between the detection circuit 242 and the gate of the controllable switch. The self-bias circuit 241 makes it possible to delay the reactivation of the controllable switch. More precisely, the self-bias circuit 241 makes it possible to delay the closing of the controllable switch by a non-zero delay corresponding to the discharge time of a capacitor C1 of the self-bias circuit 241. This makes it possible to limit the risks of degradation of the load, in particular in the case of current overloads of the pulse type.

The operating principle of the control unit 24 illustrated in FIG. 3 in the case of an electrical assembly including a storage capacitor 26 as illustrated in FIG. 2, will now be described. In this case, a current overload can be caused during the pre-charge of the storage capacitor.

At startup of the electrical equipment 23 to be protected, the storage capacitor 26 causes a strong current draw. This induces the occurrence of a current overload in the electric circuit. The detection circuit 242 detects a voltage variation at the output terminals of the load protection device. When this voltage variation becomes greater than the threshold voltage defined by the Zener diode D4, the control circuit 243 transmits a blocking signal to the gate of the controllable switch of the conduction branch 22.

The blocking signal passes through the self-bias circuit 241. The capacitor C1 of the self-bias circuit 241 is being charged. Simultaneously with the charging of the capacitor C1, the application of the blocking signal to the gate induces the opening of the controllable switch: the conduction branch 22 is deactivated.

The load protection device then operates according to its first operating mode: the entire current derived from the electrical energy supply source 25 is transmitted to the load 23 via the limitation branch 21 so that the current received by the load 23 is limited to the target intensity value to protect the load 23.

When the storage capacitor 26 is being charged, a steady state of the electric circuit is established. The voltage variation at the output of the protection device decreases, the detection circuit 242 detecting this decrease. When the voltage difference at the output becomes lower than the threshold voltage defined by the avalanche component D4, the blocking signal is interrupted.

The capacitor C1 of the self-bias circuit 241 is discharged towards the gate of the controllable switch so as to maintain it in a blocked state a few moments. This makes it possible to delay the closing of the controllable switch. When the capacitor C1 is discharged, the gate of the controllable switch is no longer powered. The controllable switch then switches from a blocked (i.e. open) state to an on-state (i.e. closed state).

The conduction branch 22 is reactivated. The load protection device then operates according to its second operating mode: the current derived from the electrical energy supply source 25 is transmitted to the load 23 through the limitation branch 21 on the one hand and through the conduction branch 22 on the other hand.

In case of current overload in a steady state (for example if a lightning impact strikes the electric circuit), the detection circuit 242 detects a voltage variation at the output greater than the threshold voltage defined by the Zener diode D4. The control circuit 243 transmits to the gate of the controllable switch a blocking signal through the self-bias circuit 241. This blocking signal opens the controllable switch to deactivate the conduction branch 22.

The first operating mode is implemented. When the voltage at the output of the protection device becomes lower than the threshold voltage, the control unit 24 controls the reactivation of the conduction branch 22 as described above.

5. Monolithic Component

In one variant, the limitation 21 and conduction 22 branches can be integrated in a unitary monolithic component made of silicon or silicon carbide (or another, preferably wide bandgap, semiconductor material) such as a JFET transistor or a MOSFET transistor or a bipolar transistor.

This makes it possible to limit the space occupied by the second branch, and therefore the space requirement of the protection device.

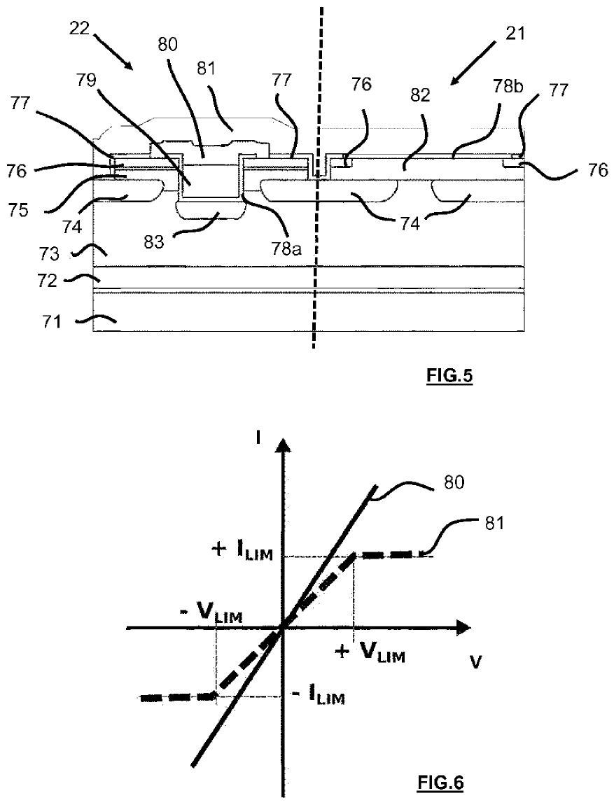

FIGS. 4 and 5 illustrate two exemplary embodiments of a monolithic component integrating the limitation 21 and conduction 22 branches on the same substrate.

With reference to FIG. 4, the monolithic component has a JFET-type structure. It comprises a substrate 61 common to the limitation 21 and conduction 22 branches. The rear face of the N-type doped substrate 61 comprises a more heavily N-doped lower layer 62 covered with a metal layer 63 forming the drain. The front face of the substrate 61 comprises P-doped buried regions 64 on which is disposed an N-type upper layer forming a lateral channel of the limitation 21 and conduction 22 branches. P-type upper regions 68 are arranged on this upper layer 70. These regions partially cover the upper layer 70.

Above the upper regions 68 and the upper layer 70, first and second metal electrodes 65a, 65b are disposed. These first and second electrodes 65a, 65b form a control gate of the branch 22 and define the characteristics of the limitation branch 21.

The monolithic component comprises a first separation trench to define the limitation 21 and conduction 22 branches. This first trench extends through the upper layer 70 of the component up to the buried regions 64 to allow their connection.

More precisely, the first separation trench extends over a depth at least equal to that of the upper layer 70.

A layer of electrically insulating material 66 covers the first metal electrode 65a forming a gate of the branch 21, while no electrically insulating material layer covers the second electrode 65b forming a gate.

A metal layer 67 forming a source covers the entire surface of the monolithic component. Therefore:

the first electrode 65a forming the gate is electrically insulated from the metal layer 67 forming a source: this first stack of layers of the monolithic component constitutes the conduction branch 22 whose gate (first electrode) is intended to be electrically connected to the control unit 24, while the drain 63 and the source 67 are intended to be connected respectively to the input terminal 31 and output terminal 32 of the load protection device;

the second electrode 65b forming a gate is in electrical contact with the metal layer 67 forming a source: this second stack of layers of the monolithic component constitutes the current limitation branch 21 whose gate 65b and source 67 are intended to be connected to the output terminal 32 of the load protection device, while the drain 63 is intended to be connected to the input terminal 31 of the device.

The particularity of the monolithic JFET-structure component illustrated in FIG. 4 is that the conduction branch 22 is activated unless an electric voltage is applied to the gate electrode (known as “NORMALLY ON”), the limitation branch being permanently activated.

The monolithic component illustrated in FIG. 5 differs from the component illustrated in FIG. 4 in that its structure is of the MOSFET type. The particularity of the monolithic MOSFET-structure component illustrated in FIG. 5 is that the conduction branch 22 is deactivated unless an electric voltage is applied to the gate electrode, the limitation branch being permanently activated.

It comprises a substrate 73 common to the limitation 21 and conduction 22 branches. The rear face of the N-type doped substrate 73 comprises a more heavily N-doped lower layer 72 covered with a metal layer 71 forming a drain. The substrate comprises first P-doped buried regions 74 at its upper face. The front face of the substrate 73 is covered by an N-type upper layer 82.

The upper layer 82 of the conduction branch 22 comprises:

second more lightly P-doped regions buried at depth 75, and

third heavily doped N-type superficially buried regions 76.

The monolithic component comprises a first trench of the MOSFET extending through the upper layer 82 up to the substrate 73. It also comprises a fourth P-type buried region 83 in the bottom of the trench, the fourth buried region 83 and the first buried regions 74 defining N-type channels in the substrate 73.

The monolithic component comprises a second separation trench to define the limitation 21 and conduction 22 branches. This second trench extends through a second central area 76 of the component up to the first regions buried 74 to allow their connection.

More precisely, the second separation trench extends over a depth at least equal to that of the upper layer 82.

First and second oxide thin layers 78a and 78b defining the gate oxide of the MOSFETs partially cover the upper face of the first buried regions 74, of the second areas 76, of the fourth buried regions 83 and of the upper layer 82.

The component comprises a first metal electrode 79 forming the control gate of the branch 22 on the first layer 78a.

A layer of electrically insulating material 80 covers the first metal electrode 79 forming the gate of the branch 21. While no electrically insulating material layer covers the second layer 78b forming the gate of the MOSFET of the limitation branch.

Metal layers 77 contact the first buried regions 74 and the second areas 76 of the limitation and conduction branches 21, 22.

A metal layer 81 forming a source covers the entire surface of the monolithic component. Therefore:

the first electrode 79 forming a gate is electrically insulated from the metal layer 81 forming a source: this first stack of layers of the monolithic component constitutes the conduction branch 22 whose gate (first electrode) is intended to be electrically connected to the control unit 24, while the drain 71 and the source 81 are intended to be connected respectively to the input terminal 31 and output terminal 32 of the load protection device;

the layer 81 covers the area 78b forming a gate is in electrical contact with the metal layer 77 forming a source: this second stack of layers of the monolithic component constitutes the current limitation branch 21 whose source 81 is intended to be connected to the output terminal 32 of the load protection device, while the drain 71 is intended to be connected to the input terminal 31 of the device.

6. Conclusions

The circuit described above is suitable for use in a direct or alternating current power grid. It makes it possible to protect electrical equipment from current overloads that could to appear in the power grid in case of startup phase of the equipment to be protected, pre-charge of a storage capacitor or lightning impact.

It can be used as a current regulator function, delivering a constant current to any AC or DC load, or be used to detect and limit any current draw on the AC or DC grid in case of overvoltage.

The reader will understand that many changes can be made to the invention described above without materially departing from the new teachings and advantages described here.

Consequently, all modifications of this type are intended to be incorporated within the scope of the appended claims.

1. A protection device for protecting an electrical equipment including:
an input terminal intended to be electrically connected to an electrical energy supply source,
an output terminal intended to be electrically connected to the electrical equipment,
wherein the protection device further comprises:
a first current limitation branch including a current source to produce a constant electric current for a given voltage range,
a second conduction branch mounted in parallel with the limitation branch,
a control unit to switch the operating mode of the device between:
a first operating mode in which the electric current derived from of the electrical energy supply source flows through the limitation branch without flowing into the conduction branch, and
a second operating mode in which the electric current derived from the electrical energy supply source flows through the limitation and conduction branches, the impedance of the conduction branch being less than or equal to 10% of the impedance of the limitation branch in the second operating mode.

2. The protection device according to claim 1, wherein the control unit is electrically connected to the conduction branch in order to monitor the activation and deactivation of said conduction branch so as to switch the device between the first and second operating modes, the limitation branch not being monitored by the control unit.

3. The protection device according to claim 1, wherein the current source comprises a transistor:
the drain of the transistor being connected to the input terminal, and
the gate and the source of the transistor being connected to the output terminal.

4. The protection device according to claim 1, wherein the current source comprises a current limiting diode.

5. The protection device according to claim 1, wherein the current limitation branch further comprises an electrical resistor mounted in series with the current source.

6. The protection device according to claim 1, wherein the conduction branch comprises a transistor:
the drain of the transistor being connected to the input terminal,
the source of the transistor being connected to the output terminal,
the gate of the transistor being connected to the control unit.

7. The protection device according to claim 1, wherein the control unit comprises:
a circuit for detecting a voltage variation at the output of the electrical equipment protection device, and/or
a circuit for detecting a current variation at the output of the electrical equipment protection device.

8. The protection device according to claim 1, wherein the control unit comprises a self-bias circuit to delay the activation of the conduction branch.

9. The protection device according to claim 1, wherein the control unit comprises a control circuit to generate a signal for blocking the conduction branch when the voltage and/or intensity at the output of the protection device is greater than a threshold value.

10. The protection device according to claim 1, wherein the limitation and conduction branches are integrated into a monolithic component.

11. The protection device according to claim 3, wherein the transistor is a JFET transistor or a MOSFET transistor.

12. The protection device according to claim 4, wherein the current limiting diode is made of silicon, silicon carbide, or any other semiconductor material.

13. The protection device according to claim 6, wherein the transistor is a JFET transistor or a MOSFET transistor.

14. The protection device according to claim 10, wherein the monolithic component is a JFET transistor or a MOSFET transistor.
